(19) United States
(12) Patent Application Publication
(10) Pub. No.: US 2008/0042429 A1
(43) Pub. Date: Feb. 21, 2008

(54) METHOD AND APPARATUS FOR COUPLING AND DECOUPLING A DEVICE AND A HEAT PIPE

(76) Inventors: Philippe Schick, Vancouver (CA); Ingo Speier, Vancouver (CA)

Correspondence Address: NEEDLE & ROSENBERG, P.C., SUITE 1000, 999 PEACHTREE STREET, ATLANTA, GA, 30309-3915, US

(21) Appl. No.: 11/840,045

(22) Filed: Aug. 16, 2007

Related U.S. Application Data
(60) Provisional application No. 60/822,693, filed on Aug. 17, 2006.

(51) Int. Cl. F16L 25/00

(52) U.S. Cl. 285/21.2; 29/890.031

(57) ABSTRACT

The present invention provides a method and apparatus for coupling a device to a heat pipe, wherein a heat transformable material is placed at the location on the heat pipe at which the device is to be coupled. The device is positioned relative to this location and in contact with the heat transformable material and subsequent heat is applied to the end of the heat pipe opposite the coupling location. The external heat which is applied to the heat pipe is transferred along the heat pipe to the proximity of the coupling location. The heat transformable material undergoes a change due to the application of heat and mates the device with the heat pipe. The heat transformable material changes into a substantially solid state upon the removal of the external heat source, thereby coupling the device to the heat pipe.

### CROSS-REFERENCE TO RELATED APPLICATION

This application claims priority to and the benefit of U.S. Provisional Application No. 60/822,693, filed Aug. 17, 2006, which is incorporated in its entirety in this document by reference.

### FIELD OF THE INVENTION

The present invention pertains to the field of connections and in particular to a method and apparatus for coupling and decoupling a device and a heat pipe.

### BACKGROUND

A heat pipe is a simple device that can quickly transfer heat from one point to another. A typical heat pipe is formed from a sealed hollow tube, which is typically manufactured from a thermally conductive material, for example copper, aluminium or the like. A heat pipe contains a working fluid therein and an internal wick structure which provide a means for liquid phase working fluid to return from a condenser end of the heat pipe to an evaporator end thereof.

As is known, a heat pipe is different from a thermosyphon in that a heat pipe is capable of heat transfer against the force of gravity through an evaporation-condensation cycle with the aid of the internal wicking structure.

The wick structure allows the capillary driving force to return the condensate, namely the liquid phase working fluid, to the evaporator end. The quality and type of wick structure usually determines the orientation dependent performance of a heat pipe. Different types of wick structures are used depending on the application for which the heat pipe is being used and these wick structures can include sintered, grooved, mesh structures or the like. In addition, working fluids can range from liquid helium for extremely low temperature applications to mercury for high temperature conditions, with various other working fluids like water, ammonia or alcohol therebetween.

An important consideration during fabrication of systems integrating heat pipes and during operation of heat pipes, is that when a heat pipe is heated above a certain temperature, which will depend on the materials from which it is fabricated, all of the working fluid in the heat pipe will vaporize and the condensation process will cease to occur; and under such conditions, the heat pipe becomes substantially ineffective. Under these conditions, there is also a potential danger of rupture of the heat pipe body, namely the sealed hollow tube, due to excessive pressure. Alternately, if the condenser end of the heat pipe becomes too cold, the working fluid may solidify and thus prevent further operation of the heat pipe.

Based on the above, the connections between a device and a heat pipe can be complicated by the thermal transport capabilities of the heat pipe. In addition, the sensitivity of the device to thermal conditions during the coupling or decoupling process can further complicate the process.

Therefore there is a need for a method of coupling and decoupling a device and a heat pipe which can be performed in an easy and repeatable manner.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method and apparatus for coupling and decoupling a device and a heat pipe. In accordance with an aspect of the present invention, there is provided a method for coupling a device to a heat pipe, the method comprising the steps of: placing heat transformable material on a first region of the heat pipe; positioning the device on the heat transformable material; heating a second region of the heat pipe with a heat source, wherein the heat pipe transfers heat from the second region of the heat pipe to the first region of the heat pipe to transform the heat transformable material into a deformable state; and removing the heat source; thereby enabling the heat transformable material to phase transform to a substantially solid format thereby coupling the device to the heat pipe.

In accordance with another aspect of the present invention, there is provided a method for decoupling a device from heat pipe, said device coupled to the heat pipe with a heat transformable material, the method comprising the steps of: heating a second region of the heat pipe with a heat source, wherein the heat pipe transfers heat to the first region of the heat pipe to transform the heat transformable material to a deformable state; decoupling the device from the heat pipe; and removing the heat source.

In accordance with another aspect of the present invention there is provided an apparatus for coupling a device to a heat pipe, the apparatus comprising: an retaining device for holding the heat pipe in a first position, the first position providing access to a first region and a second region of the heat pipe, said device being coupled to the first region using a heat transformable material; an alignment device for aligning the device relative to the first region; and a heat source configured to cooperate with the retaining device and configured to heat the second region of the heat pipe; wherein the device is coupled to the heat pipe upon transformation of the heat transformable material by the heat supplied by the heat source.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying drawings, which are incorporated in and constitute a part of this specification, illustrate several aspects of the invention and together with the description, serve to explain the principles of the invention.

FIG. 1 illustrates a light-emitting element package prior to being coupled to a heat pipe according to one embodiment of the present invention.

FIG. 2 illustrates a coupling/decoupling apparatus according to one embodiment of the present invention, which enables alignment and coupling or decoupling between a heat pipe assembly and a lighting-emitting element assembly.

FIG. 3 illustrates a coupling/decoupling apparatus according to one embodiment of the present invention, which enables alignment and coupling or decoupling between a heat pipe assembly and a lighting-emitting element assembly.

FIG. 4 illustrates a coupling/decoupling apparatus according to one embodiment of the present invention, which enables alignment and coupling or decoupling between a heat pipe assembly and a lighting-emitting element assembly.

FIG. 5 illustrates a plan view of the coupling/decoupling apparatus of FIG. 4.

### DETAILED DESCRIPTION OF THE INVENTION

The present invention may be understood more readily by reference to the following detailed description and the Examples included therein and to the Figures and their previous and following description.

Before the present apparatus, devices, and/or methods are disclosed and described, it is to be understood that this invention is not limited to specific apparatus and methods, specific heat pipes, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Thus, for example, reference to “a cooling fin assembly” includes multiple cooling fin assemblies, and the like.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. In one example, as used herein, the term “about” refers to a ±10% variation from the nominal value. It is to be understood that such a variation is always included in any given value provided herein, whether or not it is specifically referred to.

“Optional” or “optionally” means that the subsequently described event or circumstance may or may not occur, and that the description includes instances where said event or circumstance occurs and instances where it does not.

### Definitions

The term “device” is used to define a type of component which during its operation generates an amount of heat and from which heat removal is desired. A device can define a type of electrical component for example, a processor, light-emitting element or other electrical, electronic or electro-optical component as would be known to a worker skilled in the art. In addition, a device can additionally comprise a printed circuit board (PCB) or other type of board to which it is operatively connected.

The term “light-emitting element” (LEE) is used to define a device that emits radiation in a region or combination of regions of the electromagnetic spectrum for example, the visible region, infrared and/or ultraviolet region, when activated by applying a potential difference across it or passing a current through it, for example. A light-emitting element can have monochromatic, quasi-monochromatic, polychromatic or broadband spectral emission characteristics. Examples of light-emitting elements include semiconductor, organic, or polymer/polymeric light-emitting diodes, optically pumped phosphor coated light-emitting diodes, optically pumped nano-crystal light-emitting diodes or other similar devices as would be readily understood by a worker skilled in the art. Furthermore, the term light-emitting element is used to define the specific device that emits the radiation, for example a LED die, and can equally be used to define a combination of the specific device that emits the radiation together with a housing or package within which the specific device or devices are placed.

Unless defined otherwise, all technical and scientific terms used herein have the same meaning as commonly understood by one of ordinary skill in the art to which this invention belongs.

The present invention provides a method and apparatus for coupling a device to a heat pipe, wherein a heat transformable material is placed at the location on the heat pipe at which the device is to be coupled. The device is positioned relative to this location and in contact with the heat transformable material and subsequent heat is applied to the end of the heat pipe opposite the coupling location. The external heat which is applied to the heat pipe is transferred along the heat pipe to the proximity of the coupling location. The heat transformable material, undergoes a change due to the application of heat and mates the device with the heat pipe. Upon the removal of the external heat source, the heat transformable material changes into a substantially solid state thereby coupling the device to the heat pipe.

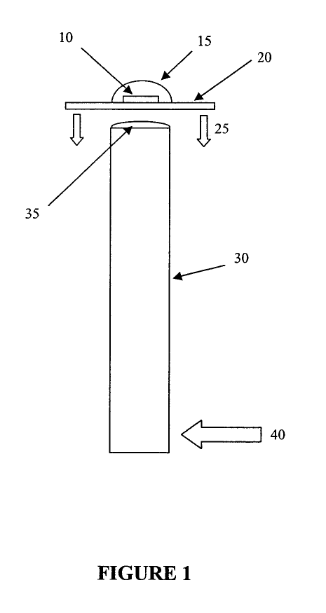

FIG. 1 illustrates a light-emitting element package prior to being coupled to the heat pipe using a method according to one embodiment of the present invention. The light-emitting element package includes light-emitting element 10 which is coupled to a substrate 20 and enclosed by lens 15. The heat pipe 30 has a heat transformable material 35 on one end thereof. Upon the application of heat 40, the light-emitting element package can be moved towards the heat pipe and a predetermined amount of pressure 25 can be applied in order to provide a desired level of contact between the heat transformable material, the light-emitting element package and the heat pipe. The heat transformable material can substantially conform to a contact surface with light-emitting element package and upon the removal of heat, the heat transformable material changes to a substantially solid form thereby forming a bond between the light-emitting element package and the heat pipe, thus coupling them together. This bond which is formed can provide for the transfer of heat generated by the light-emitting element 10 from the substrate 20 to the heat pipe and subsequently potentially to a thermal dissipation mechanism of environment.

The heat transformable material can be a type of material which is capable of change upon the application of heat and which before or after cooling thereof changes phase into a substantially solid format. The heat transformable material can be used to form either a permanent joint or a non-permanent joint. For example a heat transformable material can be a soft or hard solder, thermoplastic elastomer, thermal activated adhesive, epoxy, thermal epoxy, silicone, methacrylate, PMMA material, or other type of thermally conductive bonding material as would be known to a worker skilled in the art. In one embodiment of the present invention, the heat transformable material may be a thermally curable material for example a heat-curable adhesive, or other form of thermally curable material as would be readily understood by a worker skilled in the art.

The external heat source which is used to heat the heat pipe during the coupling or decoupling process can be selected from a wide range of heat sources. For example the heat source can be air or a heated fluid bath for example water, oil or other fluid heated bath, heated vapour or the like as would be readily understood. In addition, the heat source can be a type of heating device for example a torch, iron, radiant electric heater or other type of heating device as would be readily understood. In one embodiment of the present invention, the heat source can be in direct contact with the heat pipe, for example when the heat source is an iron. The selection of the type of heat source can be determined based on the intended use thereof, which can depend on access to the heat pipe or proximity of temperature sensitive components or materials to the heat pipe.

In one embodiment of the present invention, a hot air gun is used as the heat source due to the cleanliness, relative safety and ease of use of this type of heat source.

### Method Parameters

In one embodiment of the present invention, the heat transformable material is selected such that its transformation temperature, namely the temperature at which the phase change of the heat transformable material occurs, is less than the melting point temperature of materials which were used in previously formed connections associated with the device to be coupled. For example, the previously formed connections can include solder joints which are used to join light-emitting elements and/or other electronic components to a PCB, which together form the device which is to be coupled to the heat pipe.

In one embodiment of the present invention, the time period required for the coupling of the device and the heat pipe is selected such that the heat transformable material used has a transformation temperature which is the same or greater than the melting point temperature of materials which were used for previously formed connections associated with the device to be coupled. For example, in this embodiment, if the formation of the connection between the device and a heat pipe can be performed relatively quickly and subsequently cooled substantially rapidly, the heat transferred to the previously formed connections may be substantially minimized and previously formed connections can remain intact. These considerations can enable selection of a heat transformable material which may otherwise not have been possible due to potential thermal impact on previously formed connections during the coupling process.

In one embodiment, the heat transformable material requires an elevated temperature for an extended period of time, and therefore the heat transformable material is selected such that its transformation temperature is lower than the melting point temperature of materials which were used for previously formed connections associated with the device or heat pipe.

In one embodiment of the present invention, low temperature heat transformable materials or solders are used to help prevent heat pipe rupture due to excessive heating during the coupling process. In one embodiment of the present invention, indium tin solder with a melting point of about 118° C. is used. In other embodiments, bismuth tin with a melting point of about 138° C. or an epoxy with a cure profile around about 140° C. range can be used to couple a device to a heat pipe. Other material formats would be readily understood by a worker skilled in the art. 10037] In one embodiment of the present invention, the heat transformable material is selected such that thermal gradients and transients which are applied to electronic components associated with the device during the coupling process are substantially minimized in both duration and slope. This can be enabled by selecting a heat transferable material which has a low activation temperature or transformation temperature and a transformation time period which requires that the heat transformable material be kept at this transformation temperature for as short a time as possible.

In one embodiment of the present invention, upon removal of the heat source, active cooling is used to cool the heat pipe. In the embodiments wherein the heat transformable material is a solder or solder paste, it can be desired that this type of transformation material is not maintained in a molten state for an extended period of time, thereby substantially preventing oxidation or the formation of undesirable intermetallics in the solder joint, which may impede the desired functionality of the joint being formed.

In one embodiment of the present invention, cooling of the heat pipe can substantially immediately follow transformation of the heat transformable material, which can aid in the prevention of oxides and intermetallics forming.

In one embodiment of the present invention, the heat transformable material is selected such that the transformation temperature thereof is above the normal operation temperature of the device.

In one embodiment of the present invention, during the coupling process relative pressure is applied between the heat pipe and the device in order to enhance the resulting connection between the device and the heat pipe. For example, when applying pressure to enhance the coupling process, this pressure should be sufficient to ensure good thermal contact between the heat pipe and the device and sufficient to enable mechanical seating of the device within the heat transformable material. The pressure however, should be selected such that during the coupling process sufficient heat transformable material remains present between the device and the heat pipe before solidification, in order to provide a desired level of connection there between.

In one embodiment of the present invention, when simultaneously coupling a device to a plurality of heat pipes, substantially all mating surfaces between the device and each of the plurality of heat pipes should join adequately in terms of thermal contact and mechanical seating. In one embodiment of the present invention, wherein multiple connection points are present, the apparatus for coupling and decoupling is configured in order that all of the multiple connection points are heated and cooled at substantially the same rate.

In one embodiment of the present invention, the coupling/decoupling apparatus is configured such that the device and heat pipe do not move relative to each other during the curing or cooling phase of the coupling process. If relative movement occurs during this stage, the resulting connection may be compromised or a build up of internal stress may result in the connection between the coupled device and heat pipe.

In one embodiment of the present invention, the coupling/decoupling apparatus is configured such that a desired bond line thickness is achieved.

In one embodiment of the present invention, the coupling/decoupling apparatus provides a means to monitor and/or control of the heat pipe and/or the device temperature.

The present invention further provides a method for decoupling a device from a heat pipe, wherein the device is coupled to a first end region of a heat pipe using a heat transformable material. In accordance with one embodiment of the present invention, decoupling a device from a heat pipe comprises heating a second end region of the heat pipe with a heat source, wherein the heat pipe transfers heat to the first end region of the heat pipe thereby causing a transition of the heat transformable material, such that the heat transformable material is in a deformable or fluid state. The device can subsequently be decoupled from the heat pipe and the heat source can be removed.

The invention will now be described with reference to specific examples. It will be understood that the following examples are intended to describe embodiments of the invention and are not intended to limit the invention in any way.

### EXAMPLES

The following examples are put forth so as to provide those of ordinary skill in the art with a complete disclosure and description of how the apparatus, devices and/or methods claimed herein are made and used, and are intended to be purely exemplary of the invention and are not intended to limit the scope of what the inventors regard as their invention.

### Example 1

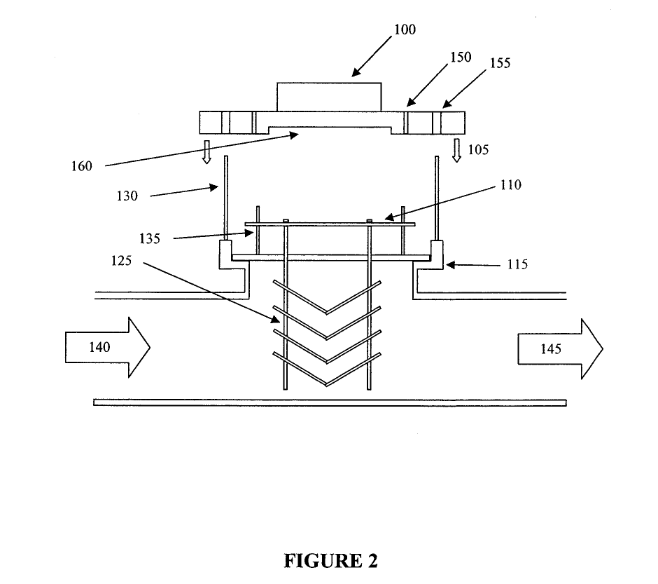

FIG. 2 illustrates a coupling/decoupling apparatus according to one embodiment the present invention, which can be used to perform a method according to the present invention.

Initially, a heat pipe/cooling fin assembly 125 is placed in the coupling/decoupling apparatus 115 which allows heated or cooled air 140 to flow over a second end of the heat pipe/cooling fin assembly, wherein the exhaust 145 exits at the opposite side of the coupling/decoupling apparatus.

In one embodiment of the present invention, a pre-coupling action is performed. In this embodiment, a desired amount of solder paste is placed on the first end of each of the heat pipes in the heat pipe/cooling fin assembly 125. Sufficiently hot air 140 is blown over the second end of the heat pipe/cooling fin assembly 125 to cause the solder paste to melt. During this process it can be possible to evaluate whether all the heat pipes are working correctly, because the solder paste on the first end of each of the heat pipes should melt at approximately the same time. The heat source is subsequently switched off, allowing the solder to solidify and thereby form solder bumps.

In this embodiment, the next sequence of steps enables the formation of a connection between the printed circuit board (PCB) 110 and the multiple heat pipes in the heat pipe/cooling fin assembly 125. The PCB 110 which is pre-assembled with light-emitting elements and other components coupled thereto using solder with the same or a higher melting point than that of the solder paste placed on the heat pipes, is placed in the coupling/decoupling apparatus such that a desired alignment between the PCB 110 and the heat pipe/cooling fin assembly is realised and contact is made with the solder bumps which were previously formed on the first end of each of the heat pipes in the heat pipe/cooling fin assembly. A pressure plate 100 is subsequently connected to the coupling/decoupling apparatus. The pressure plate 100 comprises holes 155 which fit over alignment pegs 130 of the coupling/decoupling apparatus and further comprises smaller diameter holes 150 which fit over the mounting posts 135 on the heat pipe/cooling fin assembly 125. The holes 155 and 150 are of sufficient diameter in order to allow for sufficient clearance for nuts to be secured onto the mounting posts 135 and thereby enable the tightening of the PCB 110 to the heat pipe/cooling fin assembly 125. In one embodiment of the present invention, the pressure plate further comprises an open void 160 in the central bottom region thereof which provides for clearance between the pressure plate and the light-emitting elements and other components mounted on the PCB.

The PCB is held in place with a predetermined force 105 while the heat source is reapplied to the second end of the heat pipes in the heat pipe/cooling fin assembly. This predetermined force can be applied by a weighted pressure plate which fits over the alignment posts on the coupling/decoupling apparatus. When the solder bumps melt, the predetermined force is increased by tightening the nuts on the mounting posts to predetermined torque, thereby ensuring a desired solder joint is achieved. The heat source is subsequently switched off.

Cool air is then blown over the second end of the heat pipes in the heat pipe/cooling fin assembly to accelerate the cooling process of the solder joint. During this cooling process, the heat pipes of the heat pipe/cooling fin assembly will start to operate in a manner which transfers excess heat away from the first end of the heat pipes in the heat pipe/cooling fin assembly to the second end thereof.

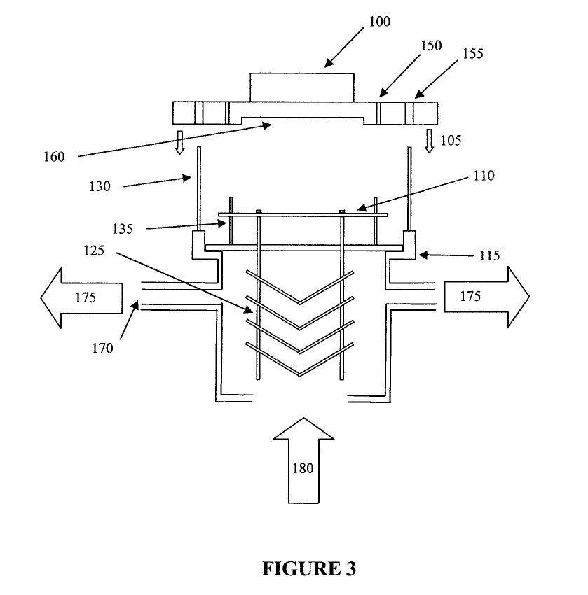

FIG. 3 illustrates a coupling/decoupling apparatus according to one embodiment of the present invention. The coupling/decoupling apparatus of FIG. 3, is similar to that illustrated in FIG. 2, however the configuration of this apparatus comprises a modification such that heat can be applied and removed with respect to the coupling/decoupling apparatus substantially symmetrically. In this embodiment, the hot air 180 is blown onto the heat pipe/cooling fin assembly 125 from below, in substantially a symmetrical arrangement. The heat can therefore be applied substantially evenly to the multiple heat pipes in the heat pipe/cooling fin apparatus, thereby substantially minimizing temperature differences between the heat pipes during the heating process. Since the heat pipes are all heated at effectively the same rate, the duration of the coupling process can thereby be reduced to substantially a minimum duration. In addition, the heat which may be transferred to the PCB 110 which may be carrying thermally sensitive components, can be substantially minimized. The hot air exits 175 the coupling/decoupling apparatus 115 via a symmetrical arrangement of holes 170 defined radially around the heat pipe/cooling fin assembly, which can also prevent unnecessary heating of the components on PCB 110. As would be readily understood, other configurations enabling essentially equal heat exposure for all of the coupling locations of a heat pipe/cooling fin assembly can are possible. For example, the hot air can be directed towards the heat pipe/cooling fin assembly in a radial fashion, and exhaust can be ejected out of the bottom of the coupling/decoupling apparatus, wherein this movement of the air is substantially in the reverse direction of that previously defined.

### Example 2

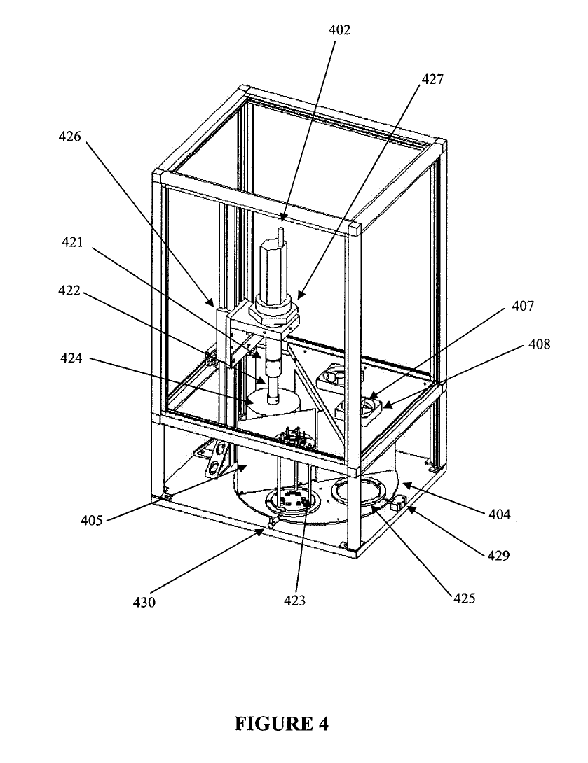

In another embodiment of the present invention, an coupling/decoupling apparatus is shown in FIG. 4 with a turntable 4 which can hold multiple heat pipe/cooling fin assemblies similar to item 125 in FIGS. 2 and 3. In this embodiment, four heat pipe/cooling fin assemblies can be supported in the apparatus at any one time, however other apparatus configurations can enable more or less heat pipe/cooling fin assemblies to be supported. The turntable 4 can be locked in each of four positions with retractable plunger 430. The heat pipe/cooling fin assemblies are inverted in this embodiment such that the coupling surfaces of the heat pipes are at the bottom. Each heat pipe/cooling fin assembly is aligned with an alignment ring 425 and rests in a cradle 423. A single hot air gun 402 on mounting plate 427 provides heat from above to one of the heat pipe/cooling fin assemblies at a time. While one heat pipe/cooling fin assembly is being heated, two others can be cooled down using fans 407 on mounting plate 408. During the heating stage the hot air gun 402 and shroud 424 are lowered on a slider 426 such that the shroud 424 half covers the heat pipe/cooling fin assembly to be heated. Hot air from the heat gun 402 passes through tube 421 which extends down into shroud 424. The portion of the tube 421 within the shroud is perforated to allow hot air from the gun to pass over the multiple heat pipes in the heat pipe/cooling fin assembly. The hot air escapes from underneath the shroud to avoid unwanted heating of the PCB 110. Movement of the slider 426 is controlled with air cylinder 422, which can be operated electronically by switch 429. A timer is included in the control system for controlling the duration of the heating phase. Heat walls 405 divide the turntable 404 into quadrants, separating the cooling and heating regions from each other.

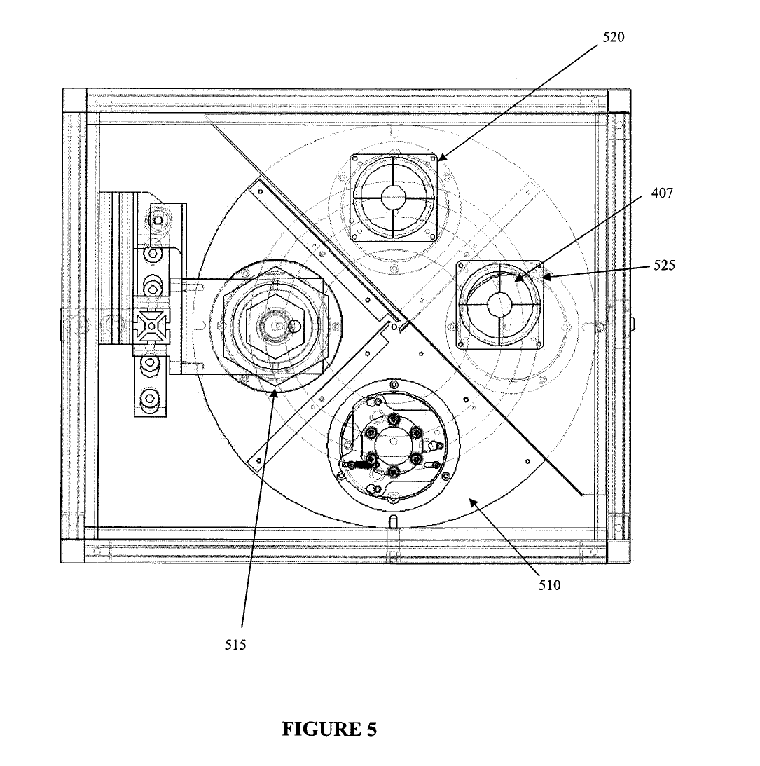

A plan view of this embodiment is shown in FIG. 5. A heat pipe/cooling fin assembly requiring coupling between the heat pipes and the devices is placed in position 510 of the turntable. The turntable is rotated a quarter of a turn clockwise, bringing the heat pipe/cooling fin assembly into position 515. In this position the hot air gun and shroud are lowered over the heat pipe/cooling fin assembly and heat is applied causing solder between the heat pipes and the components to melt. While this heat pipe/cooling fin assembly is being heated, another heat pipe/cooling fin assembly can be inserted into position 510. Following the heating stage, the heat gun and shroud are raised and the turntable rotated a further quarter turn clockwise. The heat pipe/cooling fin assembly is brought into position 520 where the heat pipes are cooled with a fan 407. Further rotation of the turntable will bring the heat pipe/cooling fin assembly into position 525 for continued cooling. Further rotation will bring the heat pipe/cooling fin assembly back into its starting position 510 from where it can be removed.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method for coupling a device to a heat pipe, the method comprising the steps of:
a) placing heat transformable material on a first region of the heat pipe;
b) positioning the device on the heat transformable material;
c) heating a second region of the heat pipe with a heat source, wherein the heat pipe transfers heat from the second region of the heat pipe to the first region of the heat pipe to transform the heat transformable material into a deformable state; and
d) removing the heat source;
thereby enabling the heat transformable material to phase transform to a substantially solid format thereby coupling the device to the heat pipe.

2. The method for coupling a device to a heat pipe according to claim 1, further comprising the step of cooling the second end region of the heat pipe.

3. The method for coupling a device to a heat pipe according to claim 1, further comprising the step of applying relative pressure between the device and the heat pipe.

4. The method for coupling a device to a heat pipe according to claim 1, wherein the heat transformable material is selected from the group comprising: solder, thermoplastic elastomer, thermal activated adhesive, epoxy, silicone methacrylate and PMMA material.

5. The method for coupling a device to a heat pipe according to claim 1, wherein the heat transformable material is indium tin solder.

6. The method for coupling a device to a heat pipe according to claim 1, wherein the heat transformable material is bismuth tin solder.

7. The method for coupling a device to a heat pipe according to claim 1, wherein the heat transformable material is a thermally curable adhesive or thermally curable material.

8. The method for coupling a device to a heat pipe according to claim 1, wherein the device includes connections formed using a material having a melting point temperature, wherein the heat transformable material is selected to have a heat transformation temperature less than the melting point temperature.

9. The method for coupling a device to a heat pipe according to claim 1, wherein the heat source is selected from the group comprising heated fluid bath and heated vapour.

10. The method for coupling a device to a heat pipe according to claim 9, wherein the heated fluid is a fluid selected from the group comprising water and oil.

11. The method for coupling a device to a heat pipe according to claim 1, wherein the heat source is a hot air gun or iron.

12. A method for decoupling a device from heat pipe, said device coupled to the heat pipe with a heat transformable material, the method comprising the steps of:
a) heating a second region of the heat pipe with a heat source, wherein the heat pipe transfers heat to the first region of the heat pipe to transform the heat transformable material to a deformable state;
b) decoupling the device from the heat pipe; and
c) removing the heat source.

13. An apparatus for coupling a device to a heat pipe, the apparatus comprising:
a) an retaining device for holding the heat pipe in a first position, the first position providing access to a first region and a second end region of the heat pipe, said device being coupled to the first region using a heat transformable material;
b) an alignment device for aligning the device relative to the first region; and
c) a heat source configured to cooperate with the retaining device and configured to heat the second region of the heat pipe;
wherein the device is coupled to the heat pipe upon transformation of the heat transformable material by the heat supplied by the heat source.

14. The apparatus for coupling a device to a heat pipe according to claim 13, wherein the retaining structure is configured to retain a heat pipe assembly comprising two or more heat pipes in the first position.

15. The apparatus for coupling a device to a heat pipe according to claim 14, wherein the retaining structure includes a heat transfer chamber, wherein the heat transfer chamber is configured to transfer heat to each of the two or more heat pipes at substantially similar rates.

16. The apparatus for coupling a device to a heat pipe according to claim 15, wherein the heat transfer chamber is configured to enable radial transfer of heat towards the heat pipe assembly.

17. The apparatus for coupling a device to a heat pipe according to claim 15, wherein the heat transfer chamber is configured enable radial extraction of heat from the heat pipe assembly.

18. The apparatus for coupling a device to a heat pipe according to claim 13, wherein the retaining structure is configured to retain a first heat pipe in the first position and retain a second heat pipe in a second position, and further configured to enable movement of the first heat pipe and second heat pipe between the first position and the second position.

19. The apparatus for coupling a device to a heat pipe according to claim 18, wherein the movement is a rotational movement.

20. The apparatus for coupling a device and a heat pipe according to claim 18, wherein the first position is a heating position and the second position is a cooling position.
